(19) United States
(12) Patent Application Publication
(10) Pub. No.: US 2016/0143434 A1
(43) Pub. Date: May 26, 2016

(54) Music Stand

(71) Applicant: Tim Cook, Liberty, TX (US)

(72) Inventor: Tim Cook, Liberty, TX (US)

(21) Appl. No.: 14/554,750

(22) Filed: Nov. 26, 2014

(51) Int. Cl. A47B 23/00; A47B 23/06; A47B 23/04; F16M 11/28

(52) U.S. Cl. CPC A47B 23/004; F16M 11/28; A47B 23/06; A47B 23/043

(57) ABSTRACT

A music stand is held by gravity between a keyboard and table, thus requiring no floor space. The music stand accommodates keyboard players of all heights, and provides, if desired, illumination to printed music placed on the stand. A horizontal anchor fits between an electronic keyboard and a supporting table on which the electronic keyboard rests. The horizontal anchor attaches to a vertical mount, preferably with a portion of the vertical mount extending above the horizontal anchor and a portion of the vertical plate extending below the horizontal plate. A rack is attached to the vertical mount and a light is attached to the rack.

### FIELD OF THE INVENTION

The present invention relates generally to the field of music stands, and, more particularly, to a music support to hold printed music, wherein the support is held in place by the weight of an electronic keyboard and is preferably not attached to a support stand.

### BACKGROUND OF THE INVENTION

Electronic keyboards are popular with professional musicians and amateurs alike. When someone buys an electronic keyboard, he typically buys a number of items with it, such as a stool, a support table to hold the keyboard at a convenient height in front of him, a set of speakers, and an amplifier. But, one often forgets that he will need something to hold printed music in front of him as he is seated at the keyboard.

There are many music stands available on the market. A typical music stand includes a base that rests on the floor, a vertical support column, and a rack coupled to the support column that holds printed music. Unfortunately, this type of music stand requires a certain amount of space between the keyboard and the wall behind it so that the keyboard takes up even greater space in the room in which it is located. Also, a typical music stand available on the market does not include a light fixture so that some sort of light source is required to see printed music placed on the music stand.

### SUMMARY OF THE INVENTION

A music stand is needed that does not take up floor space, is flexible enough to accommodate keyboard players of all heights, and provides, if desired, illumination to printed music placed on the stand. The music stand disclosed herein provides these and other features.

A horizontal plate is arranged to fit between an electronic keyboard and a support stand on which the electronic keyboard rests. The horizontal plate is attached to a vertical plate, preferably with a portion of the vertical plate extending above the horizontal plate and a portion of the vertical plate extending below the horizontal plate. A rack may be attached to the vertical plate on a side of the vertical plate away from the horizontal plate, although the rack may be attached toward the horizontal plate, and thus toward the keyboard and keyboard player. Preferably, a light is attached to the rack to provide illumination to printed music placed on the rack.

These and other features and advantages of this invention will be readily apparent to those skilled in the art.

### BRIEF DESCRIPTION OF THE DRAWINGS

So that the manner in which the above recited features, advantages and objects of the present invention are attained and can be understood in detail, more particular description of the invention, briefly summarized above, may be had by reference to embodiments thereof which are illustrated in the appended drawings.

FIG. 1 is a perspective view of an electronic keyboard with a music stand support thereby.

FIG. 2 is a side view of a music stand in an exploded aspect to illustrate the placement of a horizontal plate underneath a keyboard and above a support stand.

FIG. 3 is a front view of the music stand.

### DETAILED DESCRIPTION OF A PREFERRED EMBODIMENT

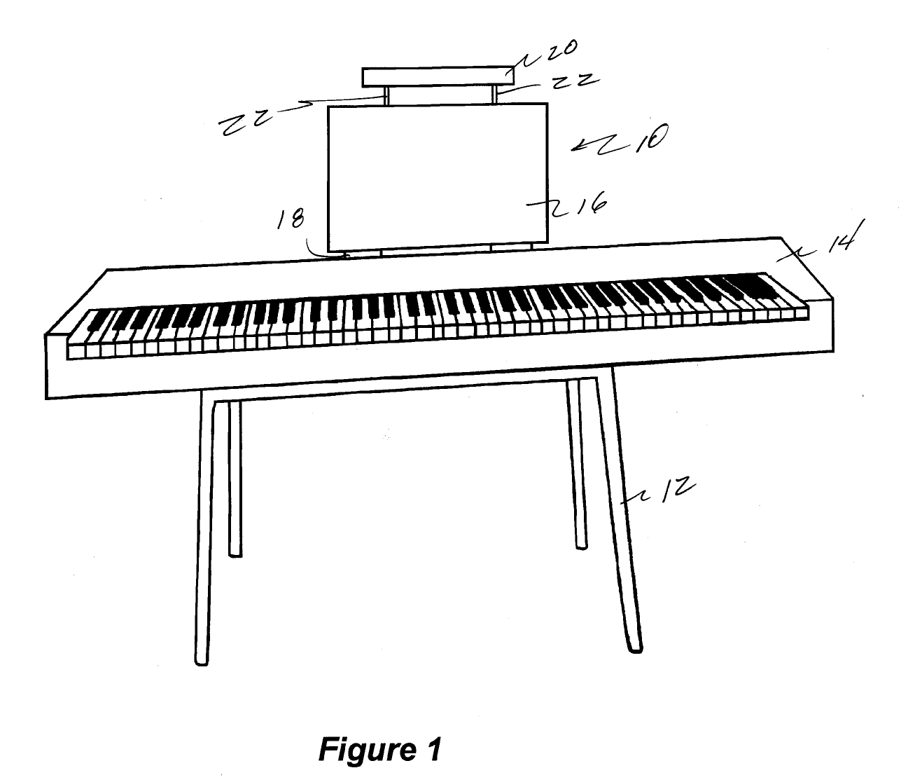

FIG. 1 illustrates a presently preferred embodiment of a music stand 10 that does not rest on the floor, but rather is preferably held in place between a table 12 and a keyboard 14. If preferred, the music stand may be coupled to the table, such as for example by nuts and bolts. A music rack 16, adapted to hold one or more sheets of printed music (not shown) is held in place by one or more upwardly-extending members 18. The one or more members 18 may be slanted or vertical, so long as they retain the rack 16 in a vertical position above the keyboard. Preferably, a lamp 20 is attached to the rack 16 to illuminate the printed music on the rack. The lamp 20 is held by one or more upwardly-extending lamp supports 22, which may be rigid or flexible to allow the desired placement and angled position of the lamp by the user.

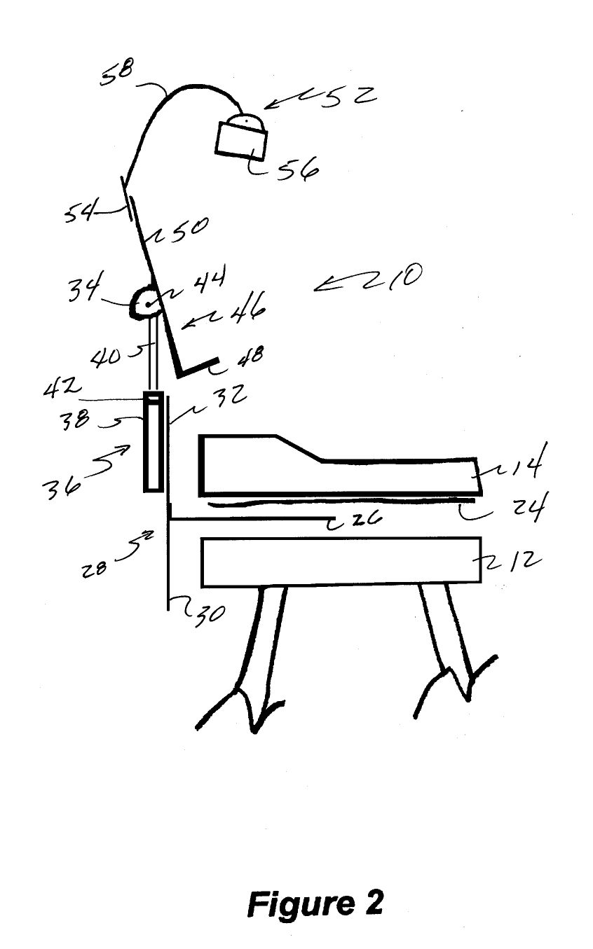

FIG. 2 depicts a side view of the music stand 10 held in place between a table 12 and a keyboard 14. FIG. 2 is shown in a slightly exploded view for ease of explanation and to clarify the invention. A purchaser of a keyboard 14 typically also buys a soft pad 24 to protect the keyboard as it rests upon the table. A substantially horizontal anchor 26 is held in place between the pad 24 and the table (or between the keyboard and table if no pad is used). The anchor 26 may comprises one or more horizontal members. The anchor 26 is coupled to a substantially vertical mount 28. The anchor and mount may be formed of a single article of manufacture or they may be permanently joined together such as by welding or similar joining technique. Alternatively, they may be joined together by nuts and bolts to reduce the size of the packaging of the product for shipping. Preferably, the vertical mount 28 includes a lower portion 30 below the anchor 26 and an upper portion 32 above the anchor.

A telescoping mount 36 is preferably joined to the vertical mount 28. As shown, the telescoping mount 36 is preferably joined to the back of the vertical mount 28, although it may be joined to the front of the vertical mount. The telescoping mount 36 comprises a cylinder portion 38 and an extending arm 40. The extending arm is held at a user-selectable position by a friction lock 42 and, when the friction lock is released, the extending arm is free to move up and down, as well as rotate within the cylinder portion.

The extending arm terminates in a swivel 34 that rotates around an axis 44 A music rack 46 is securing affixed to the swivel 34. The music rack comprises a bottom member 48 and a top member 50, formed as a unit and angled at roughly 90° to each other. The swivel permits the user to position the rack at an angle best suited to the user.

A lamp assembly 52 is mounted to the top member 50, preferably on the back of the top member, as shown. Mounting the lamp assembly to the front of the top member is more likely to interfere with sheet music held on the rack. In a preferred embodiment, the rack assembly 52 comprises a mounting plate 54, a light fixture 56, and an extension 58 coupling the mounting plate 54 to the light fixture 56. The extension may be a rigid bracket, but is preferably a flexible gooseneck to allow for flexible positioning of the fixture to suit the user. An electrical cord (not shown) powers the light fixture and runs along the music stand so that is plugged into an available outlet on the keyboard or into a wall outlet in the conventional manner.

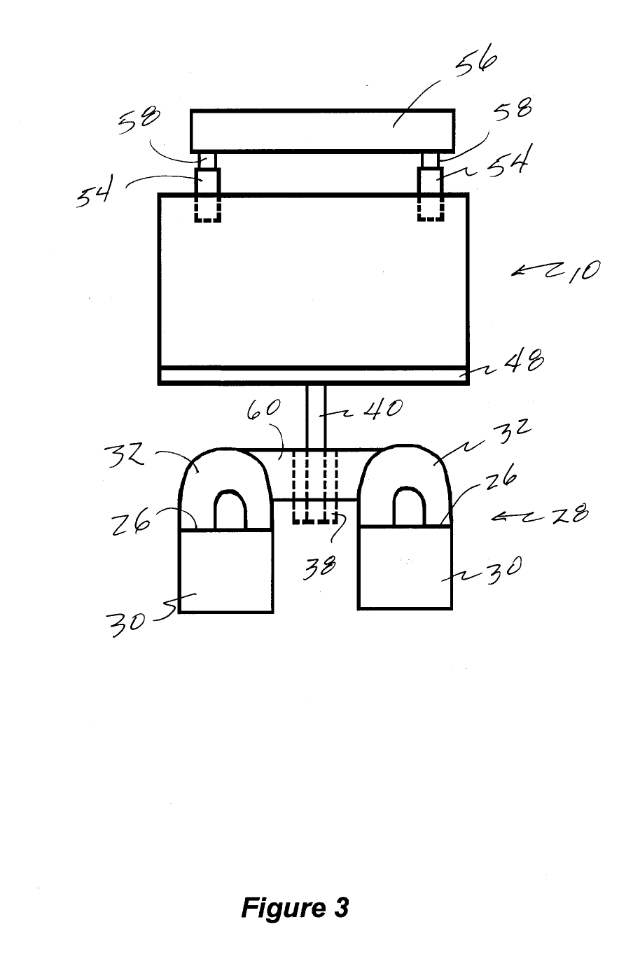

FIG. 3 depicts a front view of a presently preferred embodiment of a music rack of this invention. As previously described, the vertical mount 28 includes a lower portion 30 below the anchor 26 and an upper portion 32 above the anchor. The vertical mount 28 is shown in FIG. 3 as two side by side mounts, but they may be combined into a single mount. In the preferred embodiment of FIG. 3, the side by side mounts are coupled together with a transverse support plate 60, to which the cylinder portion 38 is affixed. The extending arm 40 extends upwardly from the cylinder portion 38 to support the music rack 46, preferably at the back of the top member 50. Also as shown in FIG. 3, the mounting plate 54 is shown as a pair of side by side plates 54, although a single support plate may be used.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

1. A music stand arranged to support a musical keyboard, the stand comprising:
a thin horizontal anchor, the anchor configured to releasably fit between a music stand and a musical keyboard;
a vertical mount attached to the horizontal anchor;
a telescoping mount attached to the vertical mount; and
a music rack attached to the telescoping mount.

2. The music stand of claim 1, further comprising a lamp assembly coupled to the music rack.

3. The music stand of claim 2, wherein the music rack defines a back side, and wherein the lamp assembly comprises:
a mounting plate attached to the back side of the music rack;
an electric lamp; and
an extension joining the electric lamp to the mounting plate.

4. The music stand of claim 3, wherein the extension comprises a gooseneck.

5. The music stand of claim 1, further comprising a swivel attaching the music rack to the telescoping mount.

6. The music stand of claim 1, wherein the vertical mount defines a lower portion and an upper portion, and wherein the horizontal anchor is attached to the vertical mount between the upper and lower portions.

7. The music stand of claim 1, wherein the telescoping mount includes a friction lock.

8. The music stand of claim 1, wherein the vertical mount comprises a pair of side by side vertical mount elements, and further comprising a transverse plate joining the side by side vertical mount elements and wherein the telescoping mount is joined to the vertical mount at the transverse plate.

9. A music stand configured to be held in place by gravity by a keyboard resting atop a portion of the music stand and a supporting table, the table resting on a floor and further defining a top surface, the music stand comprising:
a thin horizontal anchor comprising a pair of side-by-side horizontal plates, the anchor configured to releasable slide between a keyboard and a supporting table;
a vertical mount attached to the horizontal anchor, the vertical mounting comprising a vertical plate attached to each respective horizontal plate, each of the vertical plates defining a lower portion and an upper portion, the lower portion of each vertical plate extending below the top surface of the table, and wherein each of the horizontal plates is attached to a respective vertical plate between the upper and lower portions of the respective plate;
a transverse support plate joining the vertical plates;
a telescoping mount attached to the transverse support plate, the telescoping mount comprising:
a cylinder portion;
an extending arm within and extending from the cylinder portion, the extending arm defining an upper end; and
a friction lock between the cylinder portion and the extending arm;
a swivel at the upper end of the extending arm;
a music rack attached to the telescoping mount at the swivel; and
lamp assembly coupled to the music rack, the lamp assembly comprising:
a mounting plate attached to the back side of the music rack;
an electric lamp; and
a gooseneck extension joining the electric lamp to the mounting plate.

10. The music stand of claim 9, wherein the stand is entirely above and not in contact with the floor upon which the table rests.
